(19) United States
(12) Patent Application Publication
(10) Pub. No.: US 2010/0014673 A1
(43) Pub. Date: Jan. 21, 2010

(54) RADIO FREQUENCY IDENTIFICATION (RFID) AUTHENTICATION APPARATUS HAVING AUTHENTICATION FUNCTION AND METHOD THEREOF

(75) Inventors: Sang Yeoun LEE, Daejeon (KR); Heyung Sub Lee, Daejeon (KR); Su Na Choi, Daejeon (KR); You Sung Kang, Daejeon (KR); Hyunseok Kim, Daejeon (KR); Kang Bok Lee, Daejeon (KR); Seung II Myong, Daejeon (KR); Hoe-Sung Yang, Daejeon (KR); Cheol Sig Pyo, Daejeon (KR); Jong-Suk Chae, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon (KR)

(21) Appl. No.: 12/505,644

(22) Filed: Jul. 20, 2009

(30) Foreign Application Priority Data
Jul. 21, 2008 (KR) 10-2008-0070870
Sep. 23, 2008 (KR) 10-2008-0093224

(51) Int. Cl. H04L 9/06; H04L 9/00; G06F 7/04

(52) U.S. Cl. 380/270; 380/44; 340/5.8

(57) ABSTRACT

Disclosed are an RFID authentication apparatus having an authentication function and a method thereof. An RFID authentication method includes determining, by an authentication reader, an AES key using authentication information received from an authentication tag, generating an output key, encrypting a predetermined length of confirmation data by using the output key, transmitting the encrypted confirmation data to the authentication tag, receiving encrypted confirm response data corresponding to the confirmation data from the authentication tag to decrypt the encrypted confirm response data, and comparing the predetermined length of the confirmation data with the decrypted confirm response data to verify authenticity of the authentication tag.

### CROSS-REFERENCE TO RELATED APPLICATIONS

This application claims the benefit of Korean Patent Applications Nos. 10-2008-0070870 and 10-2008-0093224, respectively filed on Jul. 21, 2008 and Sep. 23, 2008 in the Korean Intellectual Property Office, the disclosures of which are incorporated herein by reference.

### BACKGROUND

1. Field of the Invention

The present invention relates to a radio frequency identification (RFID) authentication apparatus and method, and more particularly, to an RFID authentication apparatus having an authentication function and method thereof.

2. Description of the Related Art

A conventional radio frequency identification (RFID) apparatus may be used for commodity distribution management. The RFID apparatus may perform communication according to the International Organization for Standardization/International Electrotechnical Commission (ISO/EEC) 18000-6 protocol.

However, an RFID tag of the RFID apparatus has a possibility of being vulnerable to duplication, and thus, the commodity distribution management using the RFID may not have stability. Accordingly, there may be a need for an authentication server, an authentication reader, and an authentication tag which are capable of verifying authenticity of a tag.

### SUMMARY

An aspect of the present invention provides a radio frequency identification (RFID) authentication apparatus that may verify authenticity of a product by using authentication information and an advanced encryption standard (AMS) key.

According to an aspect of the present invention, there may be provided an RAID authentication apparatus including a key processor to determine an AES key by using authentication information received from an authentication tag, and to generate an output key by using the determined AES key, a confirmation data generator to encrypt a predetermined length of confirmation data by using the output key, and to transmit the encrypted confirmation data to the authentication tag, and a tag authentication unit to receive and decrypt encrypted confirmation response data corresponding to the encrypted confirmation data, and to compare the confirmation data with the decrypted confirm response data for verifying authenticity of the authentication tag.

According to an aspect of the present invention, there may be provided an RFID authentication method including determining an AES key using authentication information received from an authentication tag, generating an output key using the AES key, encrypting a predetermined length of confirmation data by using the output key, transmitting the encrypted confirmation data to the authentication tag, receiving encrypted confirm response data corresponding to the confirmation data from the authentication tag to decrypt the encrypted confirm response data, and comparing the confirmation data with the decrypted confirm response data to verify authenticity of the authentication tag.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1A is a diagram illustrating a memory map included in an authentication tag of a Radio Frequency Identification (RFID) authentication system having an authentication function according to an embodiment of the present invention;

FIG. 1B is a diagram illustrating a coefficient value of a memory map included in an authentication tag of an RFID authentication system having an authentication function;

FIG. 2 is a diagram illustrating an encryption method according to a setting of a round bit;

FIG. 3 is a block diagram illustrating a configuration of an RFID authentication system having an authentication function according to example embodiments;

FIG. 4 is a diagram illustrating a Get_SecParam command message and a response message;

FIG. 5 is a diagram illustrating a Sec_Auth command message and a response message;

FIG. 6 is a diagram illustrating a method of generating an output key required for encrypting and decrypting data in an RFID authentication system having an authentication function according to example embodiments;

FIG. 7 is a diagram illustrating an encryption method and a decryption method of an RFID authentication system having an authentication function according to example embodiments;

FIG. 8 is a flowchart illustrating an operational method of an authentication server in an RFID authentication system having an authentication function according to example embodiment;

FIG, 9 is a flowchart illustrating an operational method of an authentication tag in an RFID authentication system having an authentication function according to example embodiments;

FIG. 10 is a flowchart illustrating a procedure of communication between an authentication server, an authentication reader, and an authentication tag in an RFID authentication system having an authentication function according to example embodiments;

FIG. 11 is a message flowchart illustrating a communication procedure between an authentication server, an authentication reader, and an authentication tag of an RFID authentication system having an authentication function according to example embodiments;

FIGS. 12A through 12C are diagrams illustrating encryption and decryption in an RFID authentication system having an authentication function according to other example embodiments;

FIG. 13 is a flowchart illustrating an operational method of an authentication reader including a database of an advanced encryption standard (AES) key in an RFID authentication system having an authentication function according to other example embodiments; and

FIG. 14 is a message flowchart illustrating a communication procedure between an authentication reader including a database of an AES key and an authentication tag according to other example embodiments.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a Radio Frequency Identification (RFID) authentication system and method according to example embodiments will be described in detail with reference to attached drawings.

The RFID authentication system having an authentication function according to example embodiments includes an authentication server, an authentication reader, and an authentication tag.

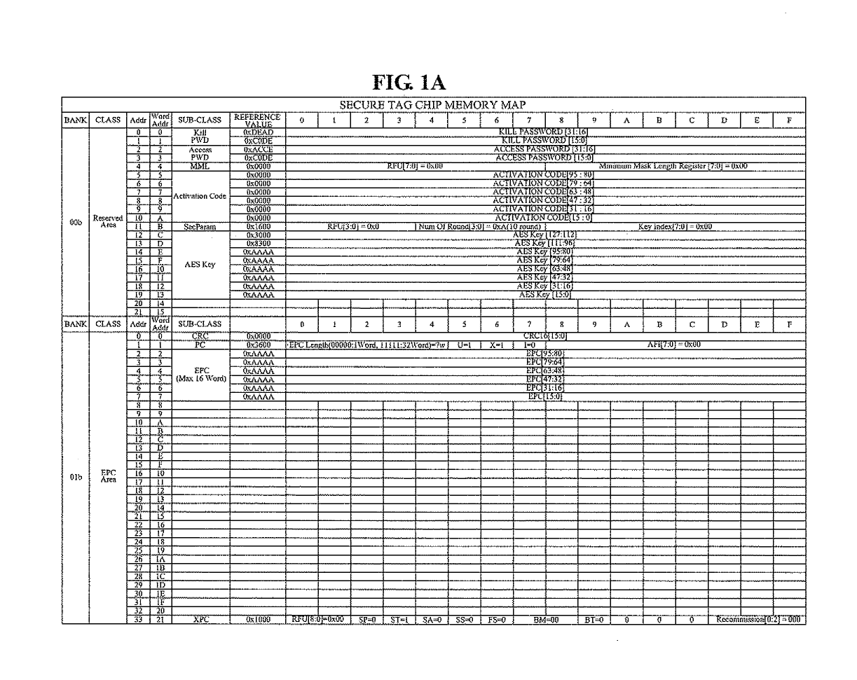

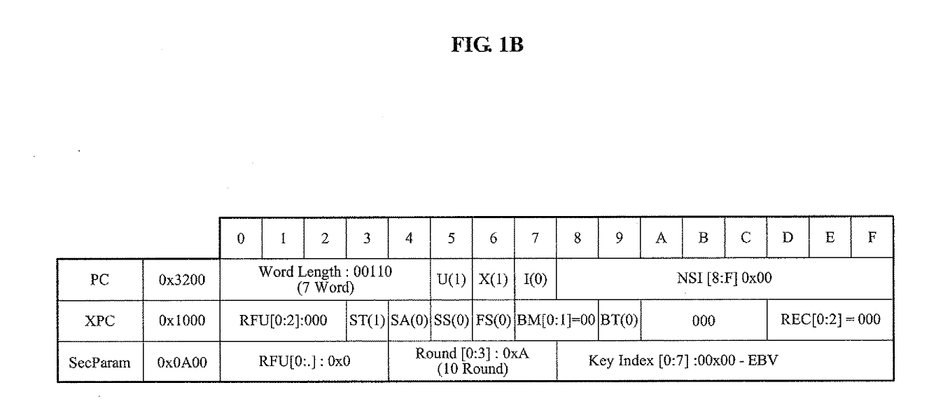

The authentication tag may be an RFID tag supporting the authentication function by using an advanced encryption standard (AES) key, and may include an authentication memory illustrated in FIGS. 1A and 1B.

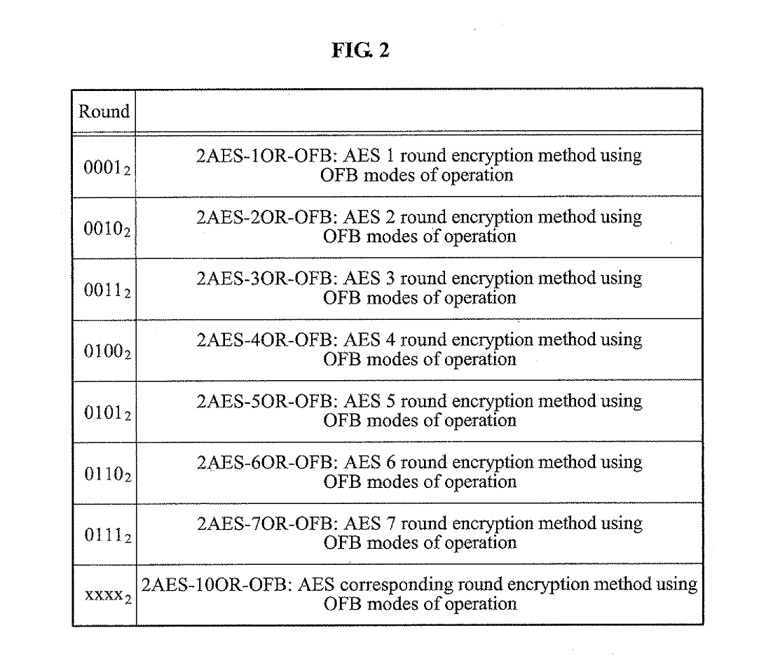

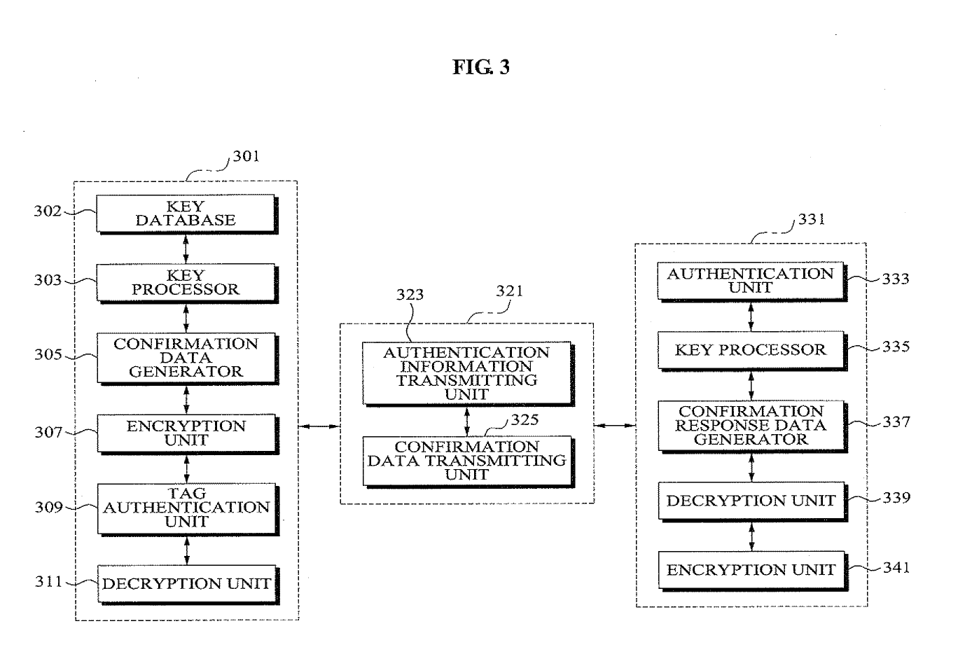

FIG. 1A is a diagram illustrating a memory map included in an authentication tag of the RFID authentication system having an authentication function according to example embodiments, and FIG. 1B is a diagram illustrating a coefficient value of a memory map included in the authentication tag of the RFID authentication system having the authentication function. FIG. 2 is a diagram illustrating an encryption method according to a setting of a round bit.

As illustrated in FIG. 1A and FIG. 1B, a security parameter (SecParam), an AES key, and the like are stored in the authentication memory.

First, the SecParam is a memory area for transmitting an encryption method and information used for the encryption algorithm, and includes a round number, an AES key index, and the like. Here, the AES key index indicates where in the authentication reader the AES key is stored.

The SecParam is constituted by an area reserved for future use (RFU: Bits 00h-3h (4 bits)), a value (round: Bits 04h-07h (4 bits)) indicating an encryption method between the authentication tag and the authentication reader, and a key index value (Key Index:Bits 08h-0Fh (8 bits)) including a key used between the authentication tag and the authentication reader.

Also, the round of the SecParam is used for generating an output key. Here, the authentication reader adjusts the round number according to a reaction time and operation power of the authentication tag. An encryption method of FIG. 2 may be provided according to the setting of the round bit.

Also, the key index may be expressed using 00000000₂˜11111111₂. Further, the key index may be defined as an extended bit vector (EBV) and may be extended according to a size of a database of a key. Also, RFU may use 0000₂ as default value.

Subsequently, the AES key that is a 128 bit private key used for generating the output key, is stored in address 12 to address 19 of the authentication memory, and requires a separate management like an access password. As an example, it is required that the AES key is set to be capable of writing only in a secured state or is set to be capable of reading and writing only in the secured state.

FIG. 3 is a block diagram illustrating a configuration of an RFID authentication system having an authentication function according to example embodiments.

Referring to FIG. 3, the RFID authentication system includes an authentication server 301, an authentication reader 321, and authentication tag 331.

The authentication server 301 includes a key database 302, a key processor 303, a confirmation data generator 305, an encryption unit 307, a tag authentication unit 309, and a decryption unit 311.

The key processor 303 determines an AES key using authentication information when receiving the authentication information from the authentication reader 321. Here, the authentication information includes electronic product code (EPC) and a SecParam. That is, the key processor 303 determines the AES key corresponding to an AES key index of the SecParam in the key database 302.

Subsequently, the key processor 303 generates an output key by using the AES key and an input key (InputKey_RN) randomly generated in the authentication server. In this instance, the input key (InputKey_RN) may be a public key.

The confirmation data generator 305 generates a predetermined length of confirmation data, and encrypts the confirmation data by using the encryption unit 307. Subsequently, the confirmation data generator 305 transmits, to the authentication reader 321, the input key and encrypted confirmation data. Here, the encryption unit 307 performs exclusive OR (XOR) with respect to the confirmation data and the output key for encrypting the confirmation data.

When receiving encrypted confirmation response data from the authentication reader 321, the tag authentication unit 309 decrypts the encrypted confirmation response data by using the decryption unit 311 and compares the confirmation data and the decrypted confirmation response data to verify authenticity of the authentication tag 331. That is, when the confirmation data and the decrypted confirmation response data are identical, the authenticated tag 331 is authenticated through the authentication reader, and thus, the tag authentication unit 309 verifies that the authentication tag is authentic, indicating the authentication tag is produced by a rightful producer. Conversely, when the confirmation data and the decrypted confirmation response data are not identical, the authenticated tag is not authenticated through the authentication reader, and thus the tag authentication unit 309 verifies that the authentication tag is not authentic, indicating the authentication tag is not produced by the rightful producer. Subsequently, the tag authentication unit 309 may transmit an authentication result to the authentication reader 321. Here, the decryption unit 311 may perform XOR with respect to the encrypted confirmation response data and the output key for decrypting the encrypted confirmation response data.

Accordingly, the encryption unit 307 encrypts input data by performing XOR with respect to the input data using the output key in a same manner that the decryption unit 311 decrypts the input data by performing XOR with respect to the input data using the output key, and thus, the encryption unit 307 and the decryption unit 311 may have a same structure.

The authentication reader 321 may further include an authentication information transmitting unit 323 and a confirmation data transmitting unit 325.

The authentication information transmitting unit 323 transmits a part of the authentication information, when receiving the authentication information from the authentication tag 331. Here, the authentication information includes protocol control (PC), extended protocol control (XPC), an EPC, and a SecParam.

In this instance, the authentication information transmitting unit 323 may receives the PC, the XPC, the EPC, and the SecParam that are transmitted after an ST bit of the XPC is identified as “1”, by the authentication tag 331.

Also, the authentication information transmitting unit 323 first receives the PC, the XPC, and the EPC among the authentication information, and the authentication information transmitting unit 323 determines that the authentication tag 331 supports the authentication function when the ST bit of the XPC is identified as “1”. Subsequently, the authentication information transmitting unit 323 may receive the SecParam from the authentication tag 331 by using a Get_SecParam command and a response message.

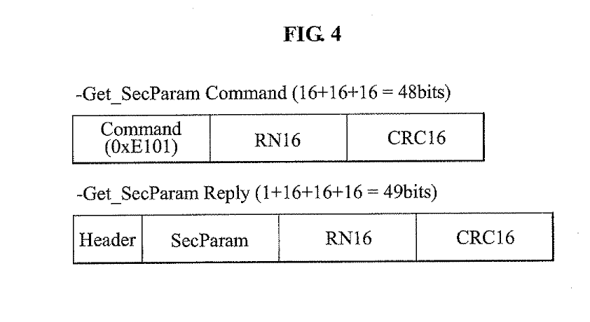

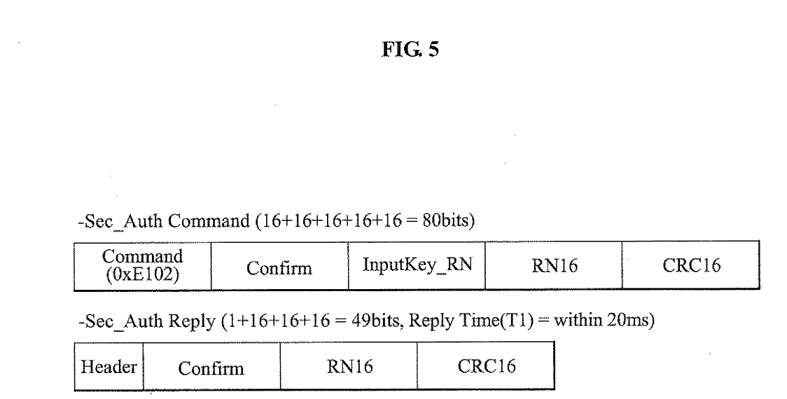

Referring to FIG. 4, the Get_SecParam command message commands the authentication reader to read a SecParam value of the authentication tag for identifying a set value of the SecParam of an authentication memory, and a code value of the Get SecParam command uses “0xE101 (11100001 00000001)”.

When receiving confirmation data from the authentication server 301, the confirmation data transmitting unit 325 transmits the confirmation data to the authentication tag 331, and when receiving confirmation response data from the authentication tag 331, the confirmation data transmitting unit 325 transmits the confirmation response data to the authentication server 301.

In this instance, the confirmation data transmitting unit 325 transmits the confirmation data to the authentication tag 331 and receives the confirmation response data from the authentication tag 331, by using a Sec_Auth command and a response data of FIG. 5.

Referring to FIG. 5, the Sec_Auth command message is a command used for verifying authenticity of the authentication tags in other words, verifying whether the authentication tag is produced by a rightful producer, using the authentication reader. The Sec_Auth command message includes confirmation data and an input key (InputKey_RN). Here, the confirmation data is randomly generated from the authentication server and is an unspecified value that is encrypted by using the AES key included in the authenticated tag and the input key (InputKey_RN) that is randomly generated from the authentication server.

A code value of the Sec_Auth command uses “0xE102 (11100001 00000010)”. In the Sec_Auth command, the confirmation data is a randomly generated 16 bit Nonce value, however, a size of the confirmation data is not limited thereto and is a variably and randomly determined value.

The authentication tag 331 includes an authentication memory 333, a key processor 335, a confirmation response data generator 337, a decryption unit 339, and an encryption unit 341.

The key processor 335 transmits the authentication information to the authentication reader 321, and generates the output key using the input key (InputKey_RN) received from the authentication reader 321. That is, the key processor 335 generates the output key using the AES key stored in the authentication memory 333 and the input key of the Sec-Auth command message received from the authentication reader 321.

The confirmation response data generator 337 generates encrypted confirmation response data corresponding to encrypted confirmation data, when receiving the encrypted confirmation data from the authentication reader 321. That is, when the confirmation response data generator 337 receives the encrypted confirmation data, the confirmation response data generator 337 decrypts confirmation data using the decryption unit 339, and re-encrypts the decrypted confirmation data using the encryption unit 341. Subsequently, the confirmation response data generator 337 transmits the encrypted confirmation response data, namely re-encrypted confirmation data, to the authentication reader 321. In this instance, the confirmation response data generator 337 transmits the encrypted confirmation response data to the authentication reader 321 within a predetermined time, for example 20 ms, after receiving the encrypted confirmation data.

Here, the decryption unit 339 performs XOR with respect to the encrypted confirmation data and the output key for decrypting the encrypted confirmation data. Also, the encryption unit 341 performs XOR with respect to the decrypted confirmation data and the output key for re-encrypting the confirmation data, thereby generating encrypted confirmation response data.

Although example embodiments describes that the authentication server in the RFID authentication system having an authentication function includes a key processor, a confirmation data generator, a tag authentication unit, and the like, and thereby verifies authenticity of the authentication tag, the example embodiments are not limited thereto. As an example, the authentication reader may include the key database, the key processor, the confirmation data generator, the encryption unit, the decryption unit, and the tag authentication unit, and thereby verifies authenticity of the authentication tag.

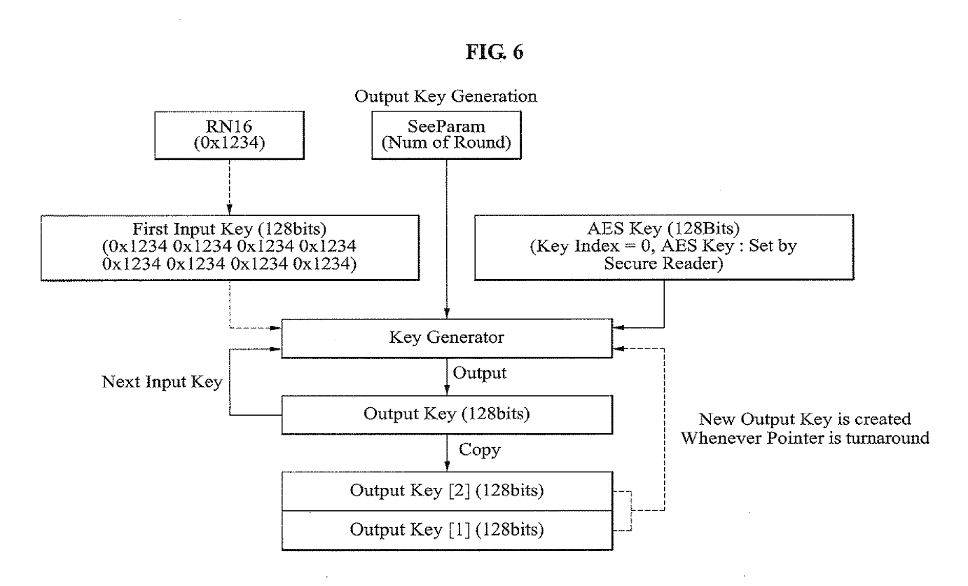

FIG. 6 is a diagram illustrating a method of generating an output key required for encrypting and decrypting data in an RFID authentication system having an authentication function according to example embodiments.

Referring to FIG. 6, a key generator receives an input key (public key), an AES key, and a round number of a SecParam to generate the output key. In this instance, the input key may be either 128 bit data generated by repeating a 16 bit input key (InputKey_RN) transmitted from the authentication server through the Sec_Auth command message or may be 128 bits data generated from the authentication server. Also, the AES key is a secret key determined between the authentication server and the authentication tag.

The key generator may generate at least two output keys in advance for smoothly operating the authentication tag. In this instance, the output key generated from the key generator may be used as an input key for generating a next output key, and thus, the key generator successively generates different output keys.

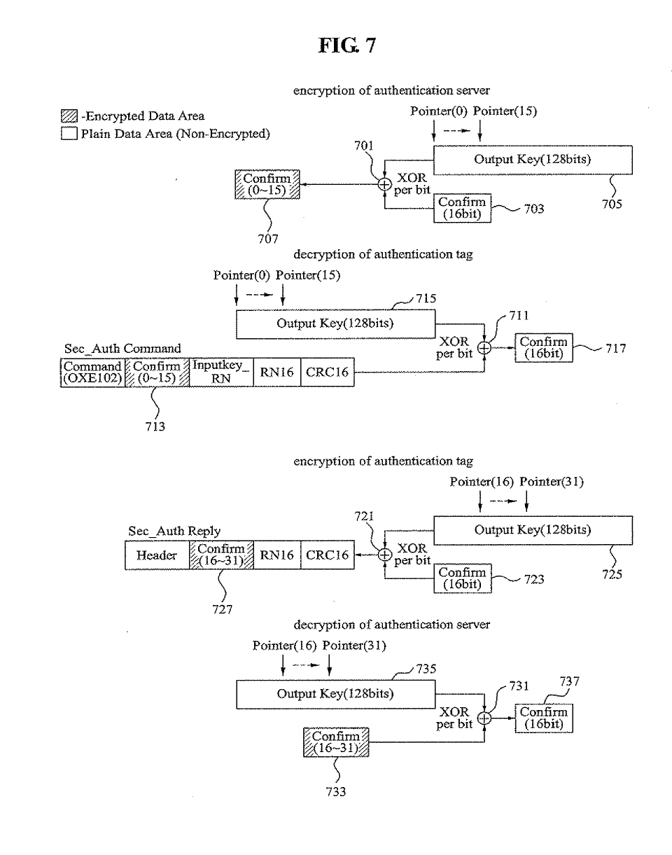

FIG. 7 is a diagram illustrating an encryption method and a decryption method of an RFID authentication system having an authentication function according to example embodiments.

Referring to FIG, 7, an encryption unit of an authentication server includes an XOR performing unit 701. The XOR performing unit 701 performs XOR with respect to confirmation data 703 to be encrypted and 0 to 15 bits of an output key 705 by a bit unit for generating encrypted confirmation data 707. The encrypted confirmation data 707 is transmitted to the authentication reader together with an input key (InputKey_RN), and the confirmation data 707 and the input key (InputKey_RN) transmitted to the authentication reader is generated as a message and transmitted to the authentication tag.

A decryption unit of the authentication tag includes an XOR performing unit 711. The XOR performing unit 711 performs XOR with respect to bits 0 to 15 of an output key 715 and encrypted confirmation data 713 included in the Sec_Auth command message by a bit unit for generating decrypted confirmation data 717.

In this instance, the output key 715 is generated by a key processor of the authentication tag using the input key (InputKey_RN) included in the Sec_Auth command message and an AES key included in an authentication memory

Also, the encryption unit of the authentication tag includes an XOR performing unit 721. The XOR performing unit 721 performs XOR with respect to confirmation data 723 to be encrypted and bits 16 to 31 of an output key 725 by a bit unit for generating encrypted confirmation data 727. In this instance, the confirmation data 723 to be encrypted may be confirmation data 717 decrypted from the decryption unit of the authentication tag. Accordingly, the XOR performing unit 721 re-encrypts the decrypted confirmation data 717 to generate the encrypted confirmation data 727.

The encrypted confirmation data 727 is constituted by a Sec_auth response message, and is transmitted to the authentication reader. Also, the confirmation data 727 transmitted to the authentication reader is transmitted to the authentication server.

Also, the decryption unit of the authentication server includes an XOR performing unit 731. The XOR performing unit 731 performs XOR with respect to encrypted confirmation data 733 and bits 16 to 31 of an output key 735 by a bit unit for generating decrypted confirmation data 737.

Subsequently, the authentication server compares the confirmation data 703 generated in the authentication server with decrypted confirmation data 737 received from the authentication reader, thereby verifying authenticity of the authentication tag.

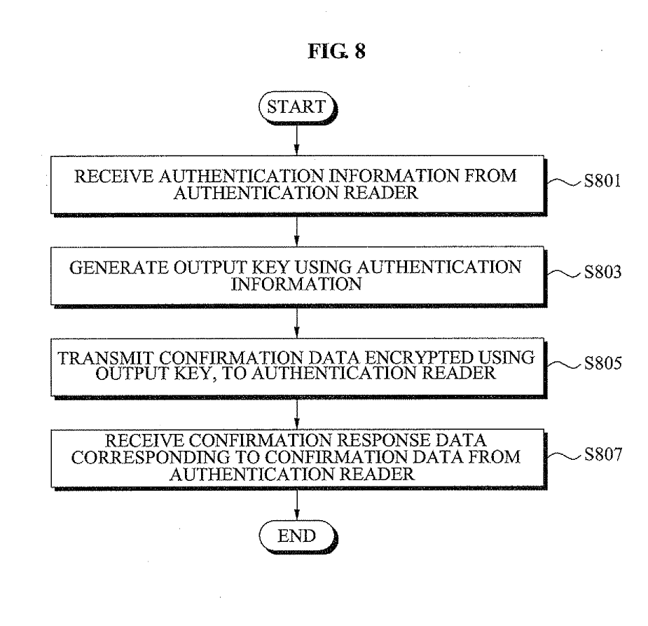

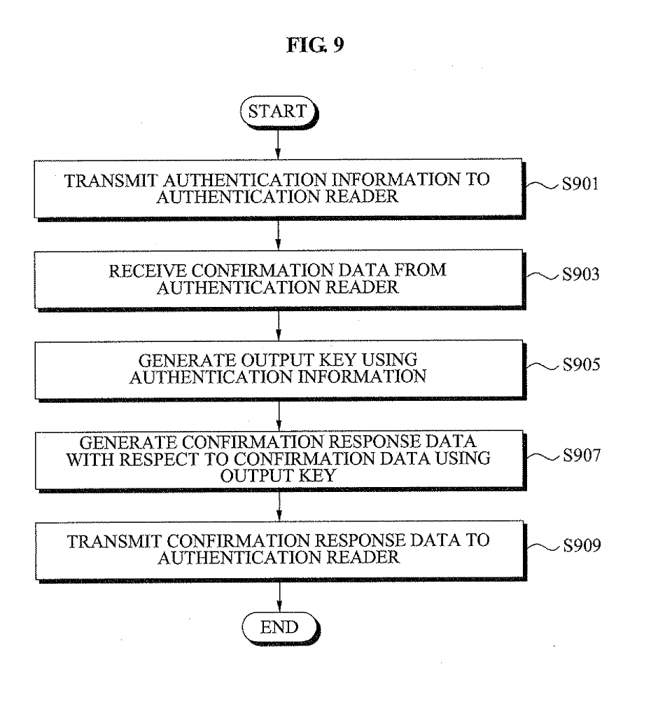

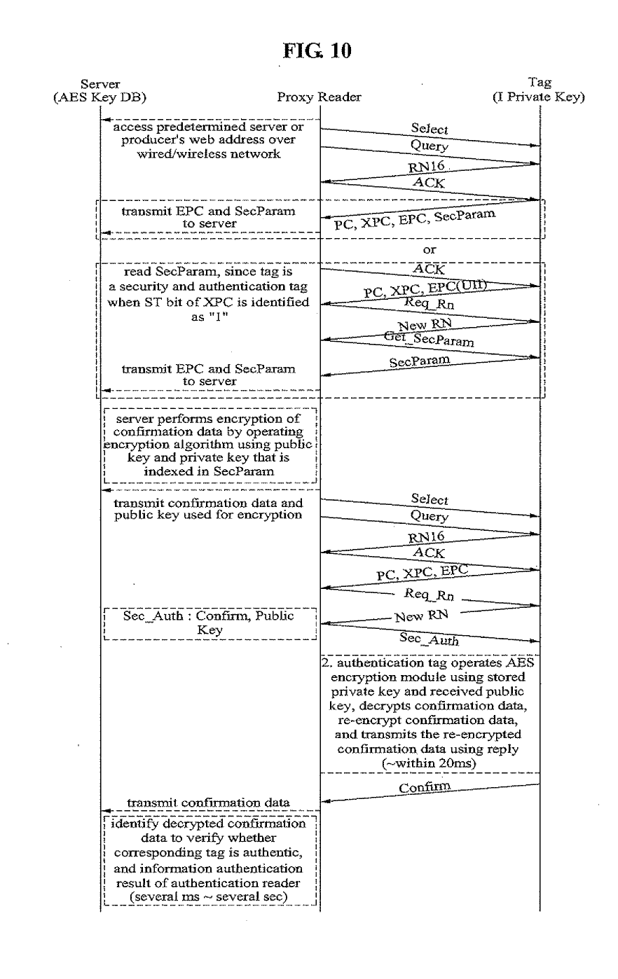

FIG. 8 is a flowchart illustrating an operational method of an authentication server in an RFID authentication system having an authentication function according to example embodiments, and FIG. 10 is a flowchart illustrating a procedure of communication between the authentication server, an authentication reader, and an authentication tag in the RFID authentication system having the authentication function according to example embodiments. Here, the authentication reader may access the authentication tag after accessing the authentication server over a wired/wireless network using a web address.

Referring to FIG. 8 and FIG. 10, the authentication server receives authentication information from the authentication reader in operation S801.

Here, the authentication information may include PC, XPC, an EPC, and a SecParam.

Subsequently, the authentication server generates an output key using the authentication information in operation S803.

Particularly, the authentication server generates an AES key based on an AES key index included in the SecParam of the authentication information. Subsequently, the authentication server generates the output key using the AES key, a round value included in the SecParam, and an input key (InputKey_RN) that is randomly generated in the authentication server.

Subsequently, the authentication server transmits confirmation data encrypted using the output key, to the authentication reader in operation S805.

Particularly, the authentication server generates a predetermined length of confirmation data and encrypts confirmation data using the output key. In this instance, the authentication server performs XOR with respect to the confirmation data and the output key for encrypting the confirmation data.

Next, the authentication server transmits the encrypted confirmation data and the input key (InputKey_RN) to the authentication reader.

Next, the authentication server receives confirmation response data corresponding to the confirmation data from the authentication reader in operation S807.

Next, the authentication server decrypts the received encrypted confirmation response data using the output key. In this instance, the authentication server performs XOR with respect to the encrypted confirmation response data and the output key for decrypting the encrypted confirmation response data.

Next, the authentication server compares the confirmation data and the confirmation response data to verify authenticity of the authentication tag in operation S809.

Particularly, when the confirmation data and the decrypted confirmation response data are identical, the authentication tag is authenticated through the authentication reader, thereby enabling the authentication server to verify that the authentication tag is authentic, indicating the authentication tag is produced by a rightful producer.

Conversely, when the confirmation data and the decrypted confirmation response data are not identical, the authenticated tag is not authenticated through the authentication reader, and thus the authentication server verifies that the authentication tag is not authentic, indicating the authentication tag is not produced by the rightful producer.

Subsequently, the authentication server transmits an authentication result to the authentication reader.

FIG. 9 is a flowchart illustrating an operational method of an authentication tag in an RFID authentication system having an authentication function according to example embodiments.

Referring to FIG. 9 and FIG. 10, the authentication tag transmits authentication information to an authentication reader in operation S901 First, the authentication tag transmits RN 16 when a slot counter of the authentication tag is ‘0’, after receiving a select message, a query message, or a query Rep message.

Subsequently, the authentication tag may transmit the authentication information to the authentication reader in two methods, and may select an appropriate method according to the authentication reader or the authentication tag.

As a first method, the authentication tag transmits the authentication information after receiving an ACK message from the authentication in response to RN16. That is, the authentication tag receives the ACK message from the authentication reader in response to the RN16, and when an ST bit of XPC is “1”, the authentication tag transmits PC, XPC, an EPC, and a SecParam of the authentication information, to the authentication reader.

As a second method, the authentication tag receives the ACK message from the authentication reader in response to the RN16, and transmits only the PC, the XPC, and the EPC of the authentication information.

Subsequently, when the authentication tag receives Req_RN from the authentication reader after the ST bit of the XPC is identified as “1” by the authentication reader that receives the PC, XPC, and EPC, the authentication tag transmits New_RN in response to the Req_RN.

Subsequently, when receiving, from the authentication reader, a Get SecParam command message for requesting the SecParam, the authentication tag transmits the SecParam to the authentication reader by transmitting a Get SecParam response message.

Subsequently, the authentication tag receives confirmation data from the authentication reader during a new inventory in operation S903.

That is, the authentication tag may receive encrypted confirmation data by receiving a Sec_Auth command message from the authentication reader.

Subsequently, the authentication tag generates an output key using the authentication information in operation S905.

Particularly, the authentication tag generates the output key using an AES key stored in an authentication memory, an input key (InputKey_RN), and a round value included in the SecParam.

Subsequently, the authentication tag generates confirmation response data with respect to the confirmation data using the output key in operation S907.

Particularly, the authentication tag decrypts encrypted confirmation data using the output key. Subsequently, the authentication tag re-encrypts the decrypted confirmation data using the output key, thereby generating encrypted confirmation response data.

Subsequently, the authentication tag transmits the confirmation response data to the authentication reader in operation S909.

That is, the authentication tag may transmit the encrypted confirmation response data by transmitting a Sec_Auth response message to the authentication reader. In this instance, the authentication tag transmits the encrypted confirmation response data within a predetermined time, for example 20 ms, after receiving the encrypted confirmation data.

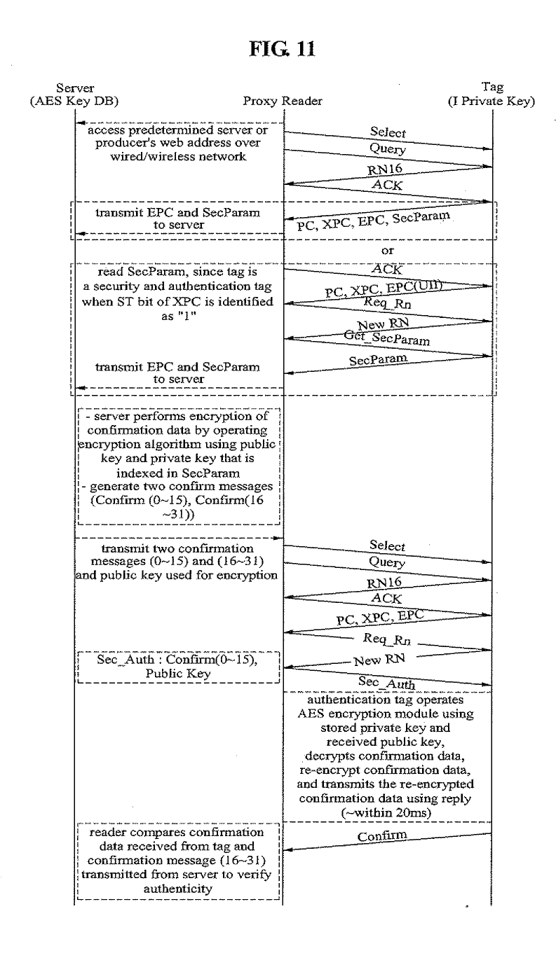

FIG. 11 is a flowchart illustrating a communication procedure between an authentication server, an authentication reader, and an authentication tag of an RFID authentication system having an authentication function according to example embodiments.

Referring to FIG. 11, the method where the authentication server receives authentication information from the authentication tag through the authentication reader and generates an output key is identical to the authentication receiving method and output key generating method of FIG. 10, and thus, description thereof will be omitted.

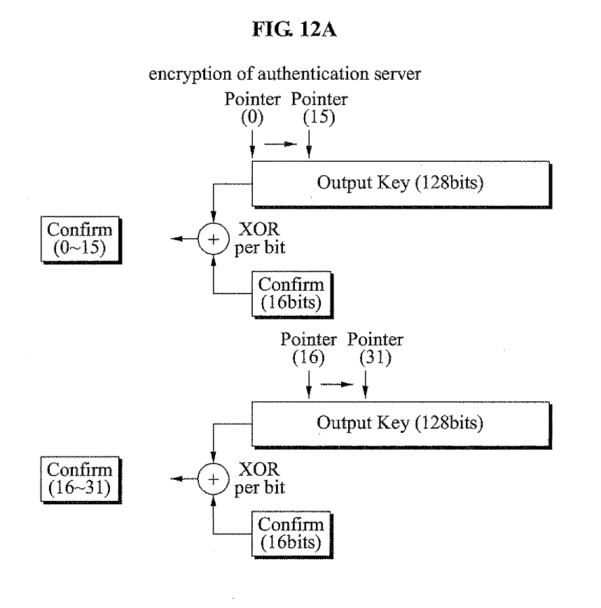

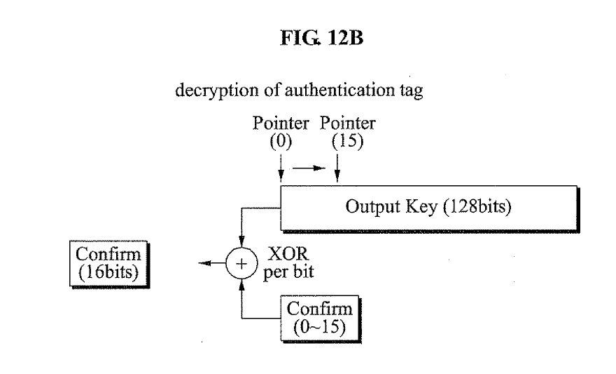

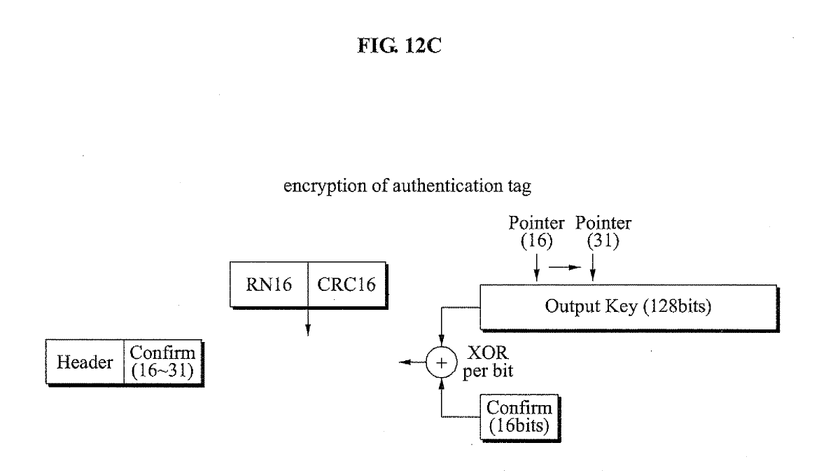

Subsequently, the authentication server performs two successive encryptions with respect to a same confirmation data using the output key. Particularly, the authentication server may generate first encrypted confirmation data and second encrypted confirmation data as illustrated in FIG. 12A, the first encrypted confirmation data being generated by encrypting randomly generated confirmation data (Confirm (16 bits)) using bits 0 to 16 of the output key and the second encrypted confirmation data being generated by encrypting randomly generated confirmation data using bits 16 to 31 of the output key. Here, although the confirmation data is described as having 16 bits, it is not limited thereto and be variable.

The authentication server transmits the first encrypted confirmation data and the second encrypted confirmation data to the authentication reader.

The authentication reader transmits the first encrypted confirmation data to the authentication tag.

As illustrated in FIG. 12B, the authentication tag decrypts the received first encrypted confirmation data using bits 0 to 5 of the output key, and as illustrated in FIG. 12C the authentication tag re-encrypts the decrypted confirmation data using bits 16 to 31 of the output key. The authentication tag transmits the re-encrypted confirmation data to the authentication reader. In this instance, the authentication tag transmits the re-encrypted confirmation data as response data with respect to the first encrypted confirmation data to the authentication reader using a Sec_Auth response message.

When receiving the response data with respect to the first encrypted confirmation data, the authentication reader compares the received encrypted response data with second encrypted confirmation data received from the authentication server for verifying authenticity of the authentication tag.

That is, when the response data with respect to the first encrypted confirmation data is identical to the second encrypted confirmation data, the authentication tag is authenticated through the authentication reader, and thus, the authentication reader verifies that the authentication tag is authentic, indicating the authentication tag is produced by a rightful producer. Conversely, when the response data with respect to the first encrypted confirmation data is identical to the second encrypted confirmation data, the authenticated tag is not authenticated through the authentication reader, and thus, the authentication reader verifies that the authentication tag is not authentic, indicating the authentication tag is not produced by the rightful producer.

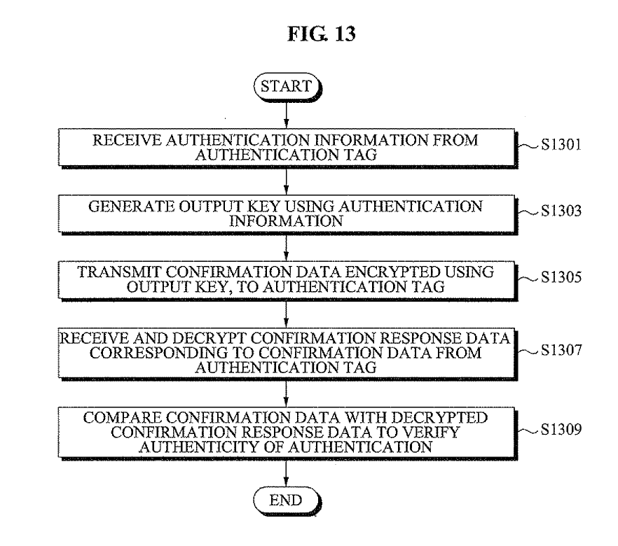

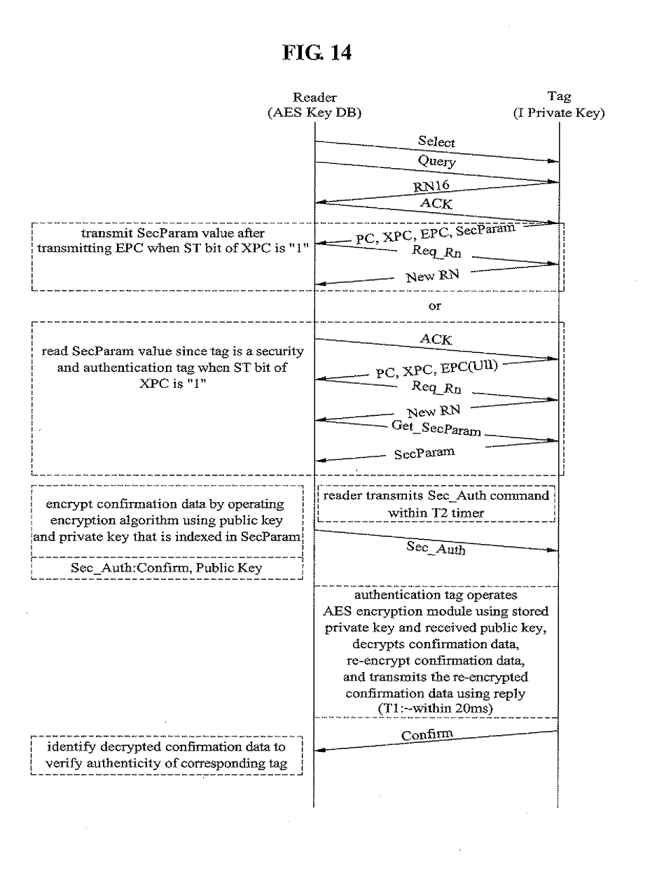

FIG. 13 is a flowchart illustrating an operational method of an authentication reader including a database of an AES key in an RFID authentication system having an authentication function according to other example embodiments and FIG. 14 is a flowchart illustrating a communication procedure between the authentication reader including the database of the AES key and an authentication tag according to other example embodiments.

Referring to FIG. 13 and FIG. 14, the authentication reader receives authentication information of the authentication tag from the authentication tag in operation S1301.

Here, the authentication information may include PC, XPC, an EPC, and a SecParam.

The authentication reader may determine whether the authentication tag supports the authentication function, using an ST bit of the XPC. That is, the authentication reader determines that the authentication tag supports the authentication function when the ST bit of the XPC is “1”.

Next, the authentication reader including the database of the AES key generates an output key using the authentication information in operation S1303.

Particularly, the authentication reader determines the AES key based on an AES key index included in the SecParam of the authentication information.

Next, the authentication reader generates the output key using the AES key, a round value included in the SecParam, and an input key that is randomly generated from the authentication reader.

Next, the authentication reader transmits confirmation data encrypted using the output key to the authentication tag in operation S1305.

Next, the authentication reader receives confirmation response data corresponding to the confirmation data from the authentication tag in operation S1307.

Next, the authentication reader decrypts the received confirmation response data using the output key.

Next, the authentication tag reader compares the confirmation data with the decrypted confirmation response data to verify authenticity of the authentication in operation S1309.

Particularly, when the confirmation data and the decrypted confirmation response data are identical, the authentication tag is authenticated through the authentication reader, and thus, the authentication reader verifies that the authentication tag is authentic, indicating the authentication tag produced by a rightful producer.

Conversely, when the confirmation data and the decrypted confirmation response data are not identical, the authenticated tag is not authenticated through the authentication reader, and thus, the authentication reader to verifies that the authentication tag is not authentic, indicating the authentication tag is not produced by the rightful producer.

The RFID authentication method having an authentication function according to example embodiments verifies authenticity of the authentication tag, thereby increasing security of the authentication tag.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A radio frequency identification (RFID) authentication apparatus, comprising:
a key processor to determine an advanced encryption standard (AES) key by using authentication information received from an authentication tag, and to generate an output key by using the determined AES key;
a confirmation data generator to encrypt a predetermined length of confirmation data by using the output key, and to transmit the encrypted confirmation data to the authentication tag; and
a tag authentication unit to receive and decrypt encrypted confirm response data corresponding to the encrypted confirmation data, and to compare the predetermined length of confirmation data with the decrypted confirm response data for verifying authenticity of the authentication tag.

2. The apparatus of claim 1, further comprising:
an encryption unit to perform exclusive OR (XOR) with respect to the predetermined length of confirmation data and the output key for encrypting the confirmation data; and
a decryption unit to perform XOR with respect to the encrypted confirm response data and the output key for decrypting the encrypted confirm response data.

3. The apparatus of claim 1, further comprising:
a key database to manage the AES key.

4. An RED authentication apparatus, comprising:
a key processor to generate, using an AES key, an output key; and
a confirm response data generator to decrypt, using the output key, encrypted confirmation data received from an authentication reader, to re-encrypt, using the output key, the decrypted confirmation data for generating an encrypted confirm response data corresponding to the encrypted confirmation data, and to transmit the encrypted confirm response data to the authentication reader.

5. The apparatus of claim 4, further comprising:
a decryption unit to perform XOR with respect to the encrypted confirmation data and the output key for decrypting the encrypted confirmation data; and
a encryption unit to perform XOR with respect to the decrypted confirmation data and the output key for re-encrypting the decrypted confirmation data.

6. An RFID authentication method, comprising:
determining an AES key using authentication information received from an authentication tag;
generating an output key using the AES key;
encrypting a predetermined length of confirmation data by using the output key;
transmitting the encrypted confirmation data to tie authentication tag;
receiving encrypted confirm response data corresponding to the confirmation data from the authentication tag to decrypt the encrypted confirm response data; and
comparing the predetermined length of the confirmation data with the decrypted confirm response data to verify authenticity of the authentication tag.

7. An RFID authentication method, comprising:
receiving encrypted confirmation data from an authentication reader;
generating an output key by using an AES key, decrypting encrypted confirmation data by using the generated output key, and re-encrypting the decrypted confirmation data by using the output key to generate encrypted confirm response data corresponding to the encrypted confirmation data; and
transmitting the encrypted confirm response data to the authentication reader.

8. The method of claim 7, wherein the transmitting of the encrypted confirm response data is performed within a predetermined time after receiving the encrypted confirmation data from the authentication reader.

9. The method of claim 7, further comprising:
transmitting authentication information to the authentication reader,
wherein the transmitting of the authentication information transmits protocol control (PC) of the authentication, extended protocol control (XPC) of the authentication, an electronic product code (EPC) of the authentication, and security parameter (SecParam) of the authentication when a bit of the XPC of the authentication is “1”.

10. The method of claim 7, further comprising:
transmitting authentication information to the authentication reader,
wherein the transmitting of the authentication information comprises transmitting PC of the authentication, XPC of the authentication, EPC of the authentication, and SecParam of the authentication, and also comprises transmitting the SecParam of the authentication to the authentication reader in response to a command of the authentication reader after the authentication reader identifies that a bit of the XPC is “1”.
